(19) United States
(12) Patent Application Publication
(10) Pub. No.: US 2002/0082140 A1
(43) Pub. Date: Jun. 27, 2002

(54) Speed change control method and device for automatic speed change gear

(75) Inventors: Kaname Suehiro, Kanagawa (JP); Yoshikazu Tanaka, Kanagawa (JP)

Correspondence Address: FOLEY AND LARDNER, SUITE 500, 3000 K STREET NW, WASHINGTON, DC, 20007, US

(73) Assignee: UNISIA JECS CORPORATION

(21) Appl. No.: 10/082,192

(22) Filed: Feb. 26, 2002

Related U.S. Application Data
(63) Continuation of application No. PCT/JP00/04214, filed on Jun. 27, 2000.

(51) Int. Cl. B60K 41/04

(52) U.S. Cl. 477/115

(57) ABSTRACT

In an automatic transmission in which an input shaft torque of the automatic transmission is estimated from an engine torque and an oil pressure during a period of gear change is controlled corresponding to the input shaft torque, the estimation value of the input shaft torque is held to a value immediately before a gear change judgment until a period of time from the gear change judgment until a changing speed of an engine rotation speed exceeds a predetermined value, and when the changing speed exceeds the predetermined value, an estimation value of the engine torque is processed by a low pass filter having a time constant corresponding to the engine rotation speed, thereby the estimation value of the input shaft torque based on the estimation value of the engine torque passing through the low pass filter.

This application is a continuation of PCT/JP00/04214 filed on Jun. 27, 2000.

### FIELD OF THE INVENTION

The present invention relates to a gear change control apparatus of an automatic transmission and a method thereof, in particular, to a gear change control apparatus and a method thereof constituted to control an oil pressure in a friction engagement element corresponding to an input shaft torque of a transmission mechanism during a period of gear change.

### BACKGROUND OF THE INVENTION

There has been disclosed in Japanese Unexamined Patent Publication No. 9-133205 or Japanese Unexamined Patent Publication No. 5-164233, a gear change control apparatus that performs a gear change by a friction engagement element replacement for carrying out simultaneously an engagement control and a release control of two different friction engagement elements.

In Japanese Unexamined Patent Publication 9-133205, there is disclosed the constitution that at a down-shift to replace a high-speed side friction engagement element with a low-speed side friction engagement element, a transfer torque capacity of the high-speed side friction engagement is raised up to be equivalent to an input shaft torque.

In Japanese Unexamined Patent Publication 5-164233, there is disclosed the constitution that, in a constitution where an input shaft torque of a transmission mechanism is estimated based on an engine torque to be used in a gear change control, an actual engine torque is estimated by applying an adjustment of a certain time delay to an intake air amount of an engine.

However, during a period of gear change with the input shaft torque being changed abruptly (at a down-shift accompanied by the depression of accelerator pedal), a waste time until the input shaft torque starts to be changed corresponding to a change in an acceleration opening is long and a response speed after the input shaft torque has started to be changed is not constant.

Therefore, in the conventional constitution where a certain time delay adjustment is applied, there is caused problems in that the input shaft torque cannot be estimated with high accuracy, and the oil pressure of the friction engagement element does not correspond to the actual input shaft torque, leading to deterioration of gear change performance.

### SUMMARY OF THE INVENTION

The present invention has been achieved in view of the foregoing problems, and it is an object of the present invention to provide a gear change control apparatus and method capable of estimating an input shaft torque even during a period of gear change when the input shaft torque is abruptly changed, to thereby improve the control precision of an oil pressure during the period of gear change.

In order to achieve the above object, according to a gear change control apparatus of an automatic transmission and a method thereof according to the present invention, the constitution is such that a waste time and a time constant to show transient characteristics of an engine torque is set based on an engine operating condition, a delay correction based on the set waste time and time constant is made to an estimation value of the engine torque, and an input shaft torque of a transmission mechanism is estimated based on the engine torque to which the delay correction has been made.

According to the above constitution, since the waste time and the time constant is set corresponding to the engine operating condition at that time, a lapse of waste time can be judged accurately and the delay correction can be made corresponding to a response speed of the torque that is changed depending on the engine operating condition, so that the estimation accuracy of the input shaft torque is improved.

Here, the engine torque may be estimated based on an engine intake air flow amount or a throttle valve opening, and an engine rotation speed.

Further, the waste time and the time constant may be set corresponding to the engine rotation speed. More specifically, it is preferable that the waste time is set to be a period of time until a changing speed of the engine rotation speed exceeds a predetermined value from when a gear change is judged, and a value of the time constant is set to be greater as the engine rotation speed is lower.

Moreover, during the time period until the waste time is elapsed from when the gear change is judged, the estimation value of the input shaft torque may be held at a value immediately before the gear change judgment, and after the lapse of the waste time, the input shaft torque may be estimated based on a result that the estimation value of the engine torque is processed by a low pass filter having the time constant.

Furthermore, after the delay correction based on the waste time and the time constant is made to the estimation value of the engine torque, the engine torque after the delay correction may be converted into the input shaft torque by a torque ratio of a torque converter.

Preferably, the period of gear change is made to be a period of down-shift accompanied by the depression of an accelerator pedal.

### BRIEF EXPLANATION OF THE DRAWINGS

FIG. 1 is a diagram showing a transmission mechanism of an automatic transmission according to an embodiment of the invention.

FIG. 2 is a diagram showing a correlation between combinations of operating conditions of friction engagement elements in the transmission mechanism, and gears.

FIG. 3 is a control block diagram showing an outline of a gear change control of the automatic transmission.

FIG. 4 is a flowchart showing an estimation control of an input shaft torque.

FIG. 5 is a chart showing characteristics of a response delay time constant in the estimation of the input shaft torque.

FIG. 6 is a time chart showing characteristics of the estimation of the input shaft torque.

### DETAILED DESCRIPTION OF THE PREFERRED EMBODIMENTS

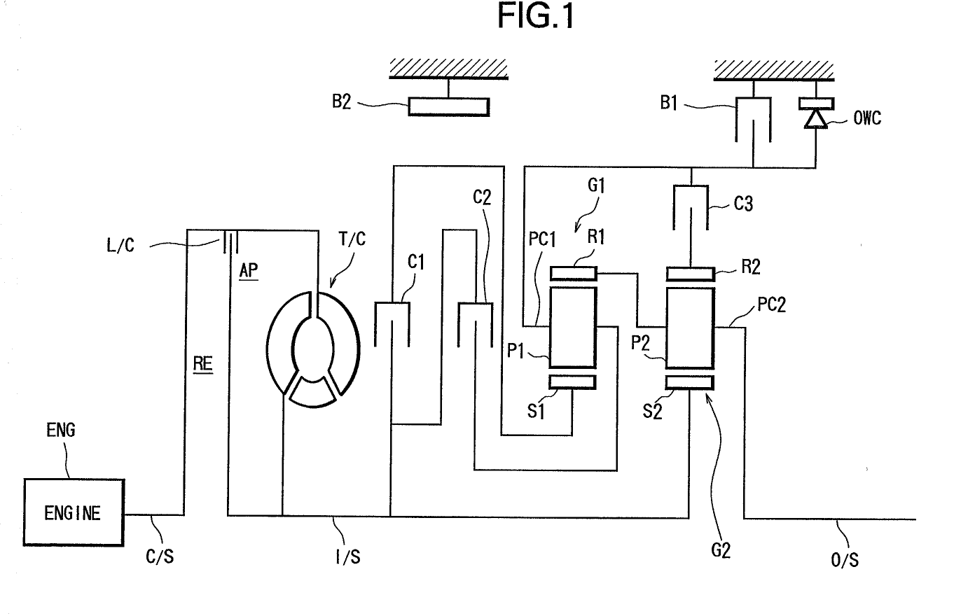

FIG. 1 shows a transmission mechanism in an automatic transmission comprising an input shaft I/S transferred with a rotation driving force from a crankshaft C/S of an engine through a torque converter T/C, an output shaft O/S arranged co-axially with input shaft I/S, a first planetary gear set G1 and a second planetary gear set G2 disposed co-axially on these input and output shafts, and various hydraulic friction engagement elements.

In the figure, L/C shows a lock-up clutch included in torque converter T/C.

First planetary gear set G1 is constituted by a simple planetary gear set comprising a sun gear S1, a ring gear R1, a pinion P1 meshed with sun gear S1 and ring gear R1, and a pinion carrier PC1 supporting pinion P1 rotatably. Also, second planetary gear set G2 is a simple planetary gear set comprising a sun gear S2, a ring gear R2, a pinion P2 meshed with sun gear S1 and ring gear R1, and a pinion carrier PC2 supporting pinion P2 rotatably.

Further, the transmission mechanism is equipped with, as the various hydraulic friction engagement elements, first to third clutches C1, C2 and C3, a first brake B1, a second brake B2, and a one-way clutch OWC.

Pinion carrier PCd is connectable with input shaft I/S through second clutch C2. Sun gear S1 is fixable by second brake B2 and is fixed to input shaft I/S by first clutch C1 and at the same time, its reverse rotation is prevented by one-way clutch OWC.

Ring gear R1 is integrally connected with carrier PC2 and is drivably connected with output shaft O/S, to connect sun gear S2 with input shaft I/S. Ring gear R2 is constituted to be connectable with carrier PC1 through third clutch C3.

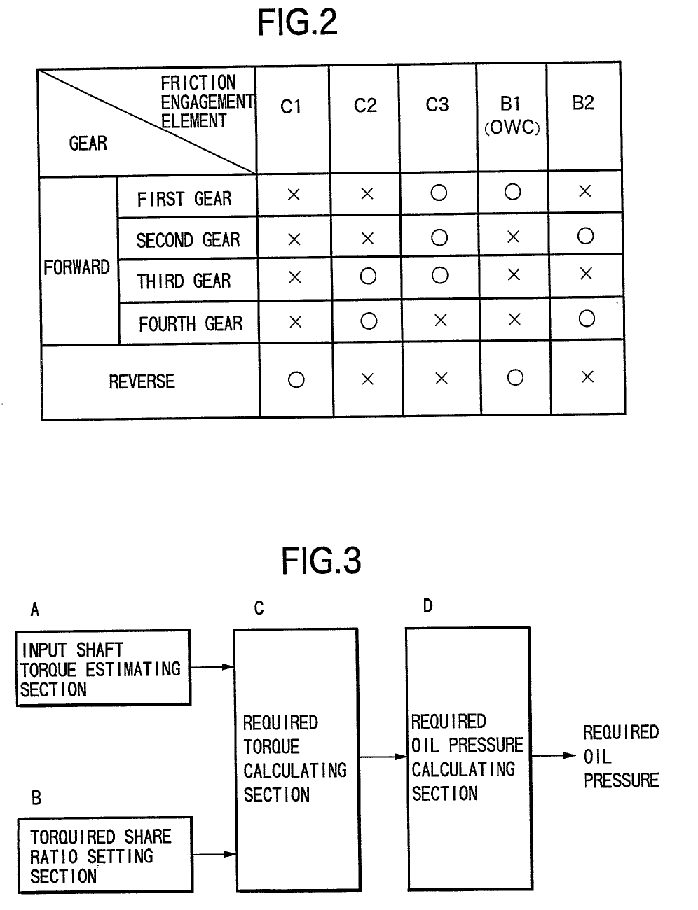

First to third clutches C1, C2 and C3, and first brake B1, and second brake B2 are operated by the supply of oil pressure thereto, respectively, to conduct the connection and fixation. As shown in FIG. 2, due to the operations of first to third clutches C1, C2 and C3, and first brake B1, and second brake B2 by various combinations (indicated by “o” mark) together with the operation of one-way clutch OWC, it becomes possible to change rotation conditions of elements constituting the planetary gear sets G1, G2, to thereby change a rotation speed ratio of output shaft O/S to a rotation speed of input shaft I/S, so that gear change ranges of forward first to four gears and a rearward first gear can be obtained.

When an engine brake is necessary at the first gear, first brake B1 is operated at the first gear. In a case where first brake B1 is not operated, although the first gear is achieved since one-way clutch OWC receives a reaction force, the engine brake cannot be operated due to the running idle of one-way clutch OWC.

For example, at the up-shift timing of, for example, third gear→fourth gear, a release control of third clutch C3 and an engagement control of second brake B2 are performed simultaneously. At the down-shift timing of fourth gear→third gear, an engagement control of third clutch C3 and a release control of second brake B2 are performed simultaneously. By such a replacement of these friction engagement elements, the gear change is performed.

The control of an engagement oil pressure of the friction engagement elements in the replacement gear change is performed as shown in FIG. 3.

In FIG. 3, at an input shaft torque estimating section A, the input shaft torque of the transmission mechanism is estimated. The estimation of the input shaft torque will be described in detail later.

A torque share ratio setting section B sets a torque share ratio so as to gradually change a torque transmission share from the friction engagement element on the release side to the friction engagement element on the engagement side during the period of gear change.

At a required torque calculating section C, based on the input shaft torque estimated at input shaft torque estimating section A and the torque share ratio set at torque share ratio setting section B, a required torque of each of the friction engagement elements during the period of gear change is calculated according to the following formula:

required torque=torque share ratio×estimated input shaft torque×gain.

At a required oil pressure calculating section D, an oil pressure required for obtaining the required torque of each friction engagement element calculated at required torque calculating section C is calculated according to the following formula, as an example of use of a clutch:

required oil pressure=1/A{(T·i)/(N·μ·D)+F},

wherein A is a clutch piston area (cm²), T is the estimated input shaft torque (kg·m), μ is a friction coefficient, D is a facing effective diameter, N is a number of clutches, I is the torque share ratio, and F is a return spring reaction force.

When a required oil pressure is calculated, a control signal corresponding to the required oil pressure is obtained, and the obtained control signal is output to a solenoid valve that controls a supply oil pressure to the friction engagement elements, to thereby control the supply oil pressure to the required oil pressure (oil pressure control unit).

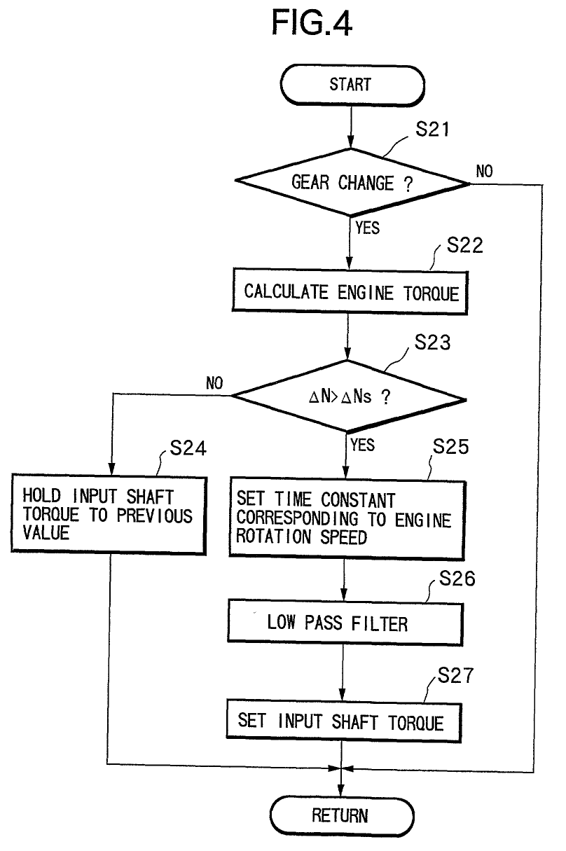

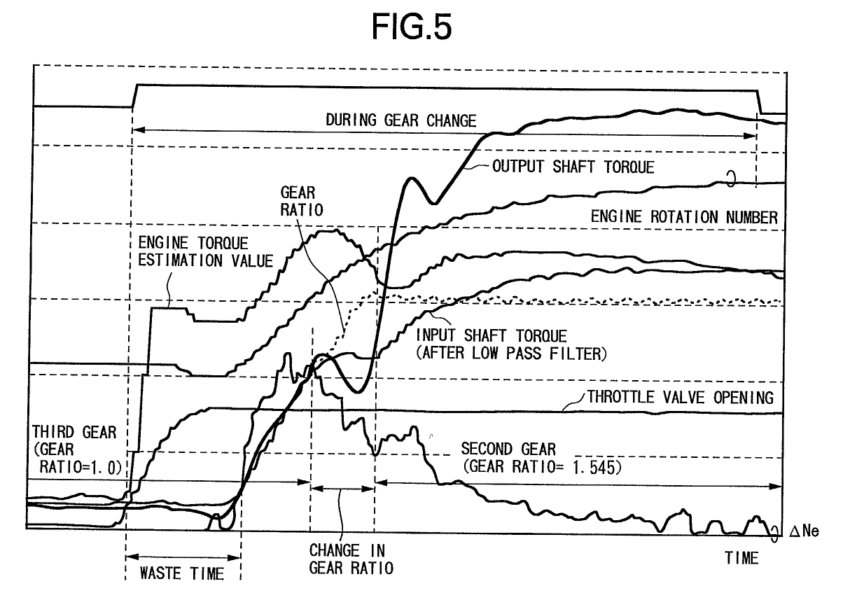

A flow chart in FIG. 4 shows an estimation process of the input shaft torque T at input shaft torque estimating section A and will be explained with reference to a time chart in FIG. 5.

The time chart in FIG. 5 shows the down-shift timing of third gear→second gear accompanied by the depression of an accelerator pedal as an example.

At Step S21, a gear change judgment is performed. If it is the time period during the period of gear change, the routine goes to Step S22, wherein the engine torque is estimated based on an intake air flow amount of the engine and an engine rotation speed (engine torque estimation unit).

At Step S22, the engine torque is estimated based on the intake air flow amount of the engine and the engine rotation speed, but a throttle valve opening may be used instead of the intake air flow amount.

At the next Step S23, it is judged whether or not a change amount ΔN (changing speed) of the engine rotation speed per unit time exceeds a predetermined value ΔNs.

Then, it is judged that, until the change amount ΔN (changing speed) exceeds the predetermined value ΔNs, it is within a waste time before the input shaft torque starts to be changed relative to an accelerator pedal opening change (throttle valve opening change) (transient characteristic setting unit), and the routine goes to Step S24, wherein a process to hold the input shaft torque estimation value immediately before the gear change judgment is executed (input shaft torque estimation unit).

The process to hold the input shaft torque estimation value may be a process to hold, as the input shaft torque, a value obtained by correcting the engine torque obtained from the intake air flow amount or the throttle valve opening immediately before the gear change judgment and the engine rotation speed at that time, with a torque ratio of the torque converter.

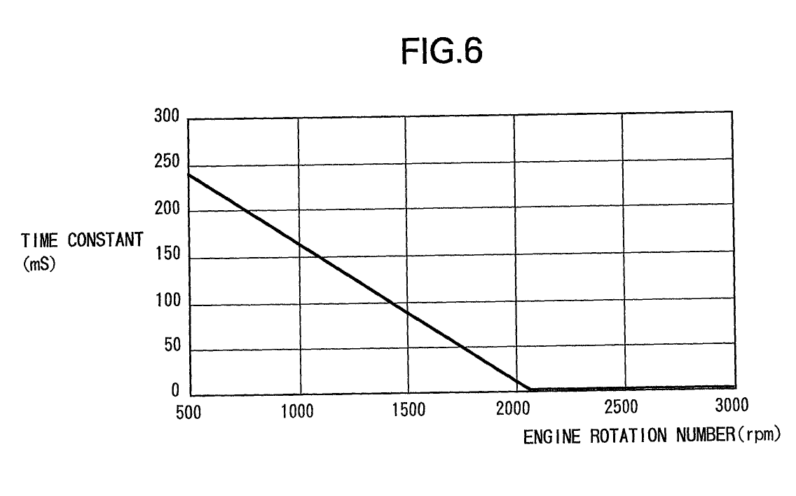

On the other hand, when it is judged that the change amount ΔN (changing speed) exceeds the predetermined value ΔNs, it is estimated that the engine torque has started to be changed relative to the accelerator pedal opening change (throttle valve opening change), and the routine goes to Step S25, wherein a time constant in transient characteristics of the engine torque is set based on the engine rotation speed (transient characteristic setting unit). Here, as shown in FIG. 6, the time constant is set greater so that as the engine rotation speed is lower, the delay becomes longer.

At Step S26, the estimation value of the engine torque is processed by a low pass filter having the set time constant. At Step S27, the estimation value processed by the low pass filter is set as the input shaft torque T (input shaft torque estimation unit).

It is preferable that before or after the engine torque estimation value is processed by the low pass filter, the estimation value is corrected corresponding to the torque ratio of the torque converter, to be set as the input shaft torque T.

The engagement oil pressure control during the replacement gear change is not limited to the above, and the engagement oil pressure may be controlled corresponding to the input shaft torque. Further, the constitution of the transmission mechanism is not limited to that in FIG. 1.

Industrial Applicability

The present invention, as explained above, achieves the high gear change performance by improving the oil pressure control precision during the period of gear change of the automatic transmission, and also enhances commercial values of vehicles by being applied to an automatic transmission for vehicle. Thereby, the present invention has a high applicability to an automatic transmission for vehicle.

What is claimed is:

1. A gear change control apparatus of an automatic transmission for controlling an oil pressure of each friction engagement element during a period of gear change corresponding to an input shaft torque of a transmission mechanism,
wherein a waste time and a time constant to show transient characteristics of an engine torque is set based on an engine operating condition, a delay correction based on said set waste time and time constant is made to an estimation value of the engine torque, and the input shaft torque of said transmission mechanism is estimated based on said engine torque to which the delay correction has been made.

2. A gear change control apparatus of an automatic transmission for controlling an engagement control and a release control of each friction engagement element by an oil pressure comprising:
an engine torque estimation unit that estimates an engine torque;
a transient characteristic setting unit that sets a waste time and a time constant to show transient characteristics of the engine torque, based on an engine operating condition;
an input shaft torque estimation unit that estimates an input shaft torque of a transmission mechanism, based on the estimation value of said engine torque, and said waste time and said time constant; and
an oil pressure control unit that controls the oil pressure of each friction engagement element during a period of gear change, based on the input shaft torque of said transmission mechanism estimated by said input shaft torque estimation unit.

3. A gear change control apparatus of an automatic transmission according to claim 2,
wherein said engine torque estimation unit estimates the engine torque, based on an engine intake air flow amount or a throttle valve opening, and an engine rotation speed.

4. A gear change control apparatus of an automatic transmission according to claim 2,
wherein said transient characteristic setting unit sets the waste time and the time constant to show transient characteristics of the engine torque, based on an engine rotation speed as the engine operating condition.

5. A gear change control apparatus of an automatic transmission according to claim 4,
wherein said transient characteristic setting unit sets, as the waste time, a time period until a changing speed of the engine rotation speed exceeds a predetermined value from when a gear change is judged.

6. A gear change control apparatus of an automatic transmission according to claim 4,
wherein said transient characteristic setting unit sets said time constant to be greater as the engine rotation speed is lower.

7. A gear change control apparatus of an automatic transmission according to claim 2,
wherein said input shaft torque estimation unit holds the estimation value of said input shaft torque at a value immediately before the gear change judgment, during the time period until said waste time is elapsed from when the gear change is judged, and after the lapse of the waste time, estimate said input shaft torque, based on a result that the estimation value of the engine torque is processed by a low pass filter having said time constant.

8. A gear change control apparatus of an automatic transmission according to claim 2,
wherein said input shaft torque estimation unit performs a delay correction based on said waste time and said time constant to the estimation value of the engine torque, and thereafter, converts said engine torque after the delay correction into the input shaft torque by a torque ratio of a torque converter.

9. A gear change control apparatus of an automatic transmission according to claim 2,
wherein said period of gear change is a period of down-shift accompanied by the depression of an accelerator pedal.

10. A gear change control method of an automatic transmission for controlling an oil pressure of each friction engagement elements during a period of gear change corresponding to an input shaft torque of a transmission mechanism, comprising the steps of:
setting a waste time and a time constant to show transient characteristics of an engine torque, based on an engine operating condition;
performing a delay correction based on said set waste time and time constant to an estimation value of the engine torque; and
estimating the input shaft torque of said transmission mechanism, based on said engine torque to which the delay correction has been made.

11. A gear change control method of an automatic transmission for controlling an engagement control and a release control of each friction engagement element by an oil pressure comprising the steps of:
estimating an engine torque;
setting a waste time and a time constant to show transient characteristics of the engine torque, based on an engine operating condition;
estimating an input shaft torque of a transmission mechanism, based on the estimation value of said engine torque, and said waste time and said time constant; and
controlling the oil pressure of each friction engagement element during a period of gear change, based on the input shaft torque of said transmission mechanism.

12. A gear change control method of an automatic transmission according to claim 11,
wherein said engine torque estimating step estimates the engine torque, based on an engine intake air flow amount or a throttle valve opening, and an engine rotation speed.

13. A gear change control method of an automatic transmission according to claim 11,
wherein the engine operating condition in said waste time and time constant setting step is an engine rotation speed.

14. A gear change control method of an automatic transmission according to claim 13,
wherein said waste time and time constant setting step sets, as the waste time, a time period until a changing speed of the engine rotation speed exceeds a predetermined value from when a gear change is judged.

15. A gear change control method of an automatic transmission according to claim 13,
wherein said waste time and time constant setting step sets said time constant to be greater as the engine rotation speed is lower.

16. A gear change control method of an automatic transmission according to claim 11,
wherein said input shaft torque estimating step holds the estimation value of said input shaft torque at a value immediately before the gear change judgment, during the time period until said waste time is elapsed from when the gear change is judged, and after the lapse of the waste time, estimate said input shaft torque, based on a result that the estimation value of the engine torque is processed by a low pass filter having said time constant.

17. A gear change control method of an automatic transmission according to claim 11,
wherein said input shaft torque estimating step performs the delay correction based on said waste time and said time constant to the estimation value of the engine torque, and thereafter, converts said engine torque after the delay correction into the input shaft torque by a torque ratio of a torque converter.

18. A gear change control method of an automatic transmission according to claim 11,
wherein said period of gear change is a period of down-shift accompanied by the depression of an accelerator pedal.
